(19) United States
(12) Patent Application Publication
(10) Pub. No.: US 2025/0211889 A1
(43) Pub. Date: Jun. 26, 2025

(54) LIMITING STRUCTURE, SUPPORT MECHANISM, AND AUDIO STAND

(71) Applicant: TILTA INC., Burbank, CA (US)

(72) Inventors: Yaolong LUO, Shenzhen (CN); Wenping ZENG, Shenzhen (CN); Kefeng ZHOU, Shenzhen (CN)

(21) Appl. No.: 18/989,617

(22) Filed: Dec. 20, 2024

(30) Foreign Application Priority Data
Dec. 21, 2023 (CN) 2023235090050

(51) Int. Cl. H04R 1/08

(52) U.S. Cl. CPC H04R 1/08

(57) ABSTRACT

This application pertains to the field of photographic equipment technology and introduces a limiting structure, a support mechanism, and an audio stand. The limiting structure encompasses a mounting component, a support component, and a locking component. The mounting component serves to install a microphone boom; the support component is movably connected to the mounting component; one end of the locking component connects to the support component, while the other end connects internally within the mounting component to secure or release the support component and the mounting component. The locking component facilitates a loose and a locked condition between the mounting component and the support component. When rotated to achieve the loose condition, the mounting component can shift relative to the support component, allowing the microphone boom mounted on it to be adjusted to a suitable angle relative to the support component. Following adjustment, the locking component can be rotated to establish the locked condition between the mounting component and the support component, thereby fixing the microphone boom at the adjusted angle.

### CROSS-REFERENCE TO RELATED APPLICATIONS

The present application for patent claims priority to and the benefit of pending Chinese Application No. 2023235090050, filed Dec. 21, 2023, and hereby expressly incorporated by reference herein as if fully set forth below in its entirety and for all applicable purposes.

### TECHNICAL FIELD

This application pertains to the field of photographic equipment technology, especially to a limiting structure, a support mechanism, and an audio stand.

### INTRODUCTION

During the production of TV dramas, movies, advertisements, live sports events, and similar endeavors, sound recording is invariably necessary. Consequently, microphones are essential equipment during filming. Conventionally, microphones are mounted on one end of a stand pole, while staff hold the other end with both hands to position the microphone near the subject. In prolonged filming scenarios, this can lead to arm soreness for the staff. In response, a novel audio stand has emerged in the market, featuring a microphone mounted on one end of the stand pole and a support pole mounted on the other. Staff can wear a backpack, attaching the end of the support pole opposite the stand pole to the backpack, thereby enabling them to hold one end of the stand pole with one hand and adjust its rotation with the other. Nevertheless, during shooting, after adjusting the angle of the microphone pole, staff often need to maintain a fixed hand position to keep the microphone pole suspended at a certain angle for good recording, which can still cause arm soreness.

### BRIEF SUMMARY

The present disclosure provides a limiting structure, support mechanism, and audio stand to overcome the issues present in the prior art, as during shooting, after adjusting the angle of the microphone pole, staff often need to maintain a fixed hand position to keep the microphone pole suspended at a certain angle for good recording, which can still cause arm soreness.

To address the aforementioned technical challenges, the technical solution offered by the present disclosure includes:

A limiting structure, including:
a mounting component, serving to install a microphone boom;
a support component, movably connected to the mounting component;
a locking component, with a first end connected to the support component and a second end connected internally within the mounting component to secure or release the support component and the mounting component.

A support mechanism that includes a support rod and the aforementioned limiting structure, wherein the support rod is movably connected to the support component.

An audio stand that incorporates a microphone boom and the aforementioned support mechanism.

### Beneficial Effects

In some aspects, the locking component facilitates a loose and a locked condition between the mounting component and the support component. When rotated to achieve the loose condition, the mounting component can shift relative to the support component, allowing the microphone boom mounted on it to be adjusted to a suitable angle relative to the support component. Following adjustment, the locking component can be rotated to establish the locked condition between the mounting component and the support component, thereby fixing the microphone boom at the adjusted angle. The present disclosure endeavors to minimize the workload on staff and avoid arm soreness.

### BRIEF DESCRIPTION OF THE DRAWINGS

To elucidate the technical solutions presented in the embodiments of the present application or the prior art, the accompanying drawings necessary for describing these embodiments or the prior art will be briefly introduced below. It is apparent that the accompanying drawings described herein represent merely some embodiments of the present application. For those skilled in the art, without the necessity for inventive effort, other drawings can be derived based on the structures depicted in these drawings.

FIG. 1 is a diagram illustrating an audio stand according to some aspects of the disclosure.

FIG. 2 is a diagram illustrating a support mechanism according to some aspects of the disclosure.

FIG. 3 is diagram illustrating an exploded diagram of the support mechanism according to some aspects of the disclosure.

### REFERENCE NUMERALS OF ELEMENTS IN THE DRAWINGS

1000—audio stand; 100—support mechanism; 10—limiting structure; 20—support rod; 30—regulating component; 301—regulating part; 302—resistance part; 200—microphone boom; 300—regulating rod;
1—mounting component; 11—limiting slot; 111—limiting projection; 12—mounting part; 13—limiting part; 131—connecting strip; 132—stiffener; 133—limiting frame; 134—avoidance space; 14—receiving part;
2—support component; 21—first mounting hole; 22—second mounting hole;
3—locking component; 31—operating part; 32—moving part; 321—sliding body;

The objectives, functional characteristics, and advantages of the present invention will be further elucidated with reference to the embodiments and accompanying drawings.

### DETAILED DESCRIPTION

The subsequent passages provide a precise and exhaustive portrayal of the technical solutions embodied within this application, drawing upon the illustrative figures. It is to be understood that the enumerated embodiments constitute but a fraction of the broader scope and are not exhaustive. Consequently, any alternative embodiments derived by ordinary technicians in the relevant field, without the necessity for inventive ingenuity, are encompassed within the protective ambit of this application.

Please be advised that directional terminology (e.g., up, down, left, right, front, rear, etc.) employed in the embodiments serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in this application, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct embodiments is permissible, albeit contingent upon the feasibility of such integration by ordinary technicians in the field. In instances where the combined technical solutions conflict or are unfeasible, such integrations are deemed non-existent and thereby excluded from the scope of protection afforded by this application.

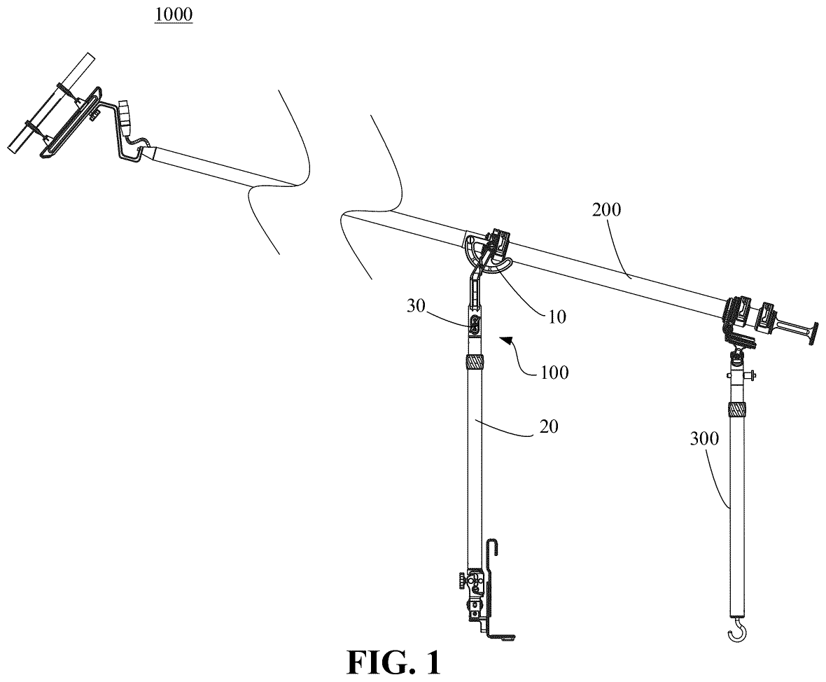

Referring to FIGS. 1-3. The present application provides an audio stand 1000 that includes a microphone boom 200 and a support mechanism 100. The support mechanism 100 encompasses a support rod 20 and a limiting mechanism. The limiting mechanism includes a mounting component 1, a support component 2, and a locking component 3. The mounting component 1 serves to mount the microphone boom 200. One end of the support component 2 is connected to the support rod 20, while the other end is movably connected to the mounting component 1, thereby enabling the support rod 20 to be movably coupled to the microphone boom 200. The support rod 20 connects to the support component 2. In some aspects, the microphone boom 200 is utilized for mounting a microphone. Personnel can load the support rod 20 onto a backpack worn on their body. They can manipulate the end of the microphone boom 200 opposite the microphone with one hand to adjust its rotation, such as pitch angle or deviation angle relative to their front and back. Upon adjustment, personnel can utilize the locking component 3 to secure the support component 2 and the mounting component 1, thereby maintaining the microphone boom 200 at the adjusted angle. With this arrangement, personnel do not need to maintain a fixed hand position.

In some aspects, a regulating rod 300 can also be provided at the end of the microphone boom 200 opposite the microphone. With this setup, personnel can grasp the regulating rod 300 with their hand to adjust the rotation of the microphone boom 200, without needing to raise their hand to hold the microphone boom 200, further alleviating the workload on personnel.

In some aspects, the support mechanism 100 further includes a regulating component 30, including a connected regulating part 301 and a resistance part 302. The support component 2 features a first mounting hole 21. The regulating part 301 is movably disposed within the first mounting hole 21, enabling the resistance part 302 to shift relative to the support component 2 to resist the support rod 20. In some aspects, when the regulating part 301 is rotated, the resistance part 302 can transition between a locked state and a loose state. When the resistance part 302 is in the loose state, the support component 2 can rotate around the axial line of the support rod 20, thereby permitting the microphone boom 200 to also rotate around the axial line of the support rod 20, allowing for flexible adjustment of the microphone position. After adjusting the position of the microphone, the resistance part 302 can be transitioned to the locked state by rotating the regulating part 301, thereby locking the support rod 20 and the support component 2. At this juncture, the microphone boom 200 can be maintained in the adjusted position. In summary, the regulating component 30 in some aspects can collaborate with the aforementioned locking component 3 to achieve flexible adjustment of the angle of the microphone boom 200, fully meeting the needs of personnel.

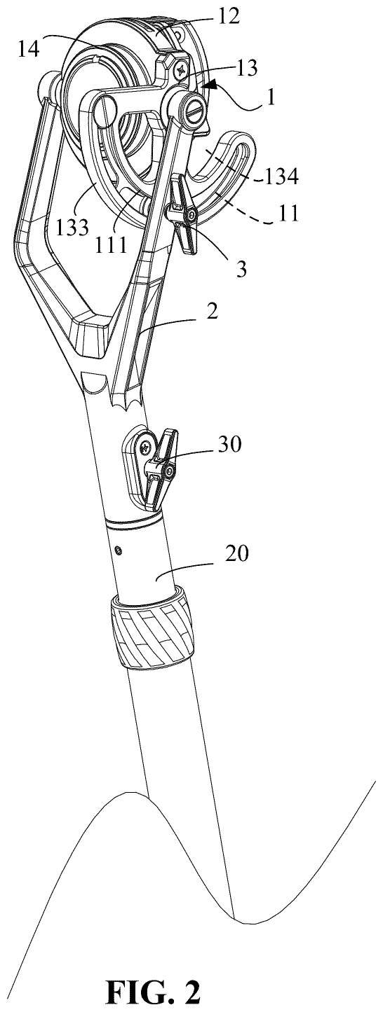

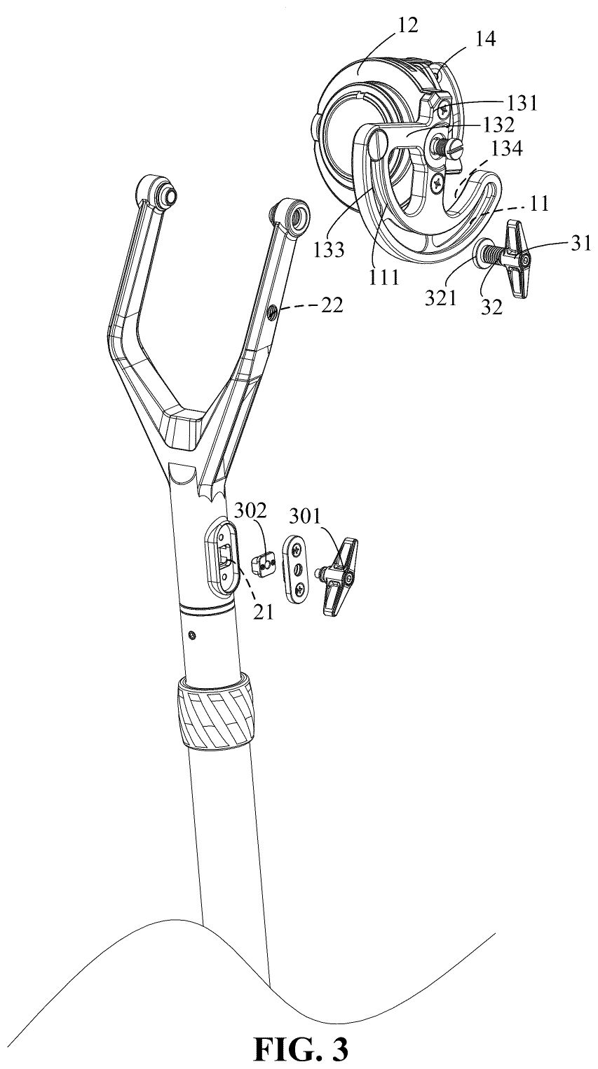

Referring to FIGS. 2-3. The limiting structure 10 includes a mounting component 1, a support component 2, and a locking component 3. The mounting component 1 is configured for mounting the microphone boom 200; the support component 2 is movably connected to the mounting component 1; one end of the locking component 3 is connected to the support component 2, and the other end is connected within the mounting component 1 to lock or release the support component 2 and the mounting component 1.

In some aspects, the locking component 3 facilitates a loose and a locked condition between the mounting component 1 and the support component 2. When rotated to achieve the loose condition, the mounting component 1 can shift relative to the support component 2, allowing the microphone boom 200 mounted on the mounting component 1 to be adjusted to a suitable angle relative to the support component 2. Following adjustment, the locking component 3 can be rotated to establish the locked condition between the mounting component 1 and the support component 2, thereby fixing the microphone boom 200 at the adjusted angle. The design endeavors to minimize the workload on staff and avoid arm soreness.

Specifically, the mounting component 1 features a limiting slot 11, and the locking component 3, connected to the support component 2, has one end housed within this limiting slot 11. When unlocked, the locking component 3 can traverse the limiting slot, enabling the support component 2 to move relative to the mounting component 1. When locked, the locking component 3 can be secured at any position within the limiting slot 11, thereby locking the support component 2 and the mounting component 1. In this application, the locking component 3 can slide along the limiting slot 11 to enhance structural stability during the relative movement of the support component 2 and the mounting component 1. It is understandable that the limiting slot 11 in some aspects can be designed as a circular arc. When the locking component 3 is unlocked, the locking component 3 can slide relative to the limiting slot 11, and the mounting component 1 can rotate relative to the support component 2, thereby enabling the microphone boom 200 to perform pitch movements, etc. When the locking component 3 is locked, the locking component 3 can be secured at any position in the limiting slot 11, thereby locking the mounting component 1 and the support component 2 together.

In some aspects, the mounting component 1 includes a mounting part 12 and a limiting part 13. Positioned between the mounting part 12 and the support component 2, the limiting part 13 features a limiting slot 11, and the limiting slot 11 confines movement scope for the locking component 3. In some aspects, the limiting part 13 includes a connecting strip 131, a stiffener 132, and a limiting frame 133. A first end of the connecting strip 131 is placed between the support component 2 and the mounting part 12, while a second end connects to the limiting frame 133. The limiting frame 133 features a limiting slot 11, with a first end of the stiffener 132 attached to one end of the limiting frame 133 and a second end connected to an end of the connecting strip 131 distant from the limiting frame 133. In some aspects, the stiffener 132 stabilizes the structural connection between the limiting frame 133 and the connecting strip 131. The limiting frame 133 may be configured to follow the arc of the stiffener 132.

In some aspects, the mounting part 12 serves to install the microphone boom 200. The aforementioned regulating rod 300 is capable of regulating the rotation of the microphone boom 200 around its central axis. Consequently, a receiving part 14 is positioned between the mounting part 12 and the microphone boom 200. The receiving part 14 is sleeved onto the surface of the microphone boom 200 and is movably connected to the mounting part 12. In some aspects, one end of the limiting frame 133 forms an avoidance space 134, allowing the regulating rod 300 to drive the rotation of the receiving part 14 without structural interference between the receiving part 14 and the limiting frame 133.

Furthermore, the locking component 3 includes an operating part 31 and a movable part 32. A first end of the movable part 32 connects to the support component 2, while a second end features a sliding body 321 gliding within the limiting slot 11. The operating part 31 attaches to an end of the movable part 32 distant from the limiting slot 11, and when rotated, the sliding body 321 can be locked within the limiting slot 11 or slide along the limiting slot 11. In some aspects, when angle adjustment of the microphone boom 200 or maintaining the microphone boom 200 at a desired angle by staff is necessary, the operating part 31 can be rotated to toggle the movable part 32 between an unlocked state and a locked state.

Specifically, a second mounting hole 22 is provided on the support component 2, with the wall of the second mounting hole 22 featuring internal threads. The outer surface of the movable part 32 is equipped with external threads. The movable part 32, distant from one end, passes through the second mounting hole 22 and connects to the operating part 31. It is understood that the internal threads of the second mounting hole 22 engage with the external threads of the movable part 32.

In some aspects, specifically, a limiting projection 111 extends inwardly from a peripheral wall towards a central area of the limiting slot 11, restricting the sliding body 321 within the limiting slot 11. In some aspects, the sliding body 321 can slide within the limiting slot 11. The limiting projection 111 on the perimeter wall of the limiting slot 11 retains the sliding body 321 within the limiting slot 11, preventing the sliding body 321 from slipping out during sliding along the limiting slot 11 and thereby enhancing the product's lifespan.

It is emphasized that the aforementioned embodiments serve as preferred illustrations and do not constitute limitations on the scope of the patent claims presented herein. Any structural modifications that are deemed equivalent, based on the disclosure and drawings of this application, or their direct/indirect application in related technical domains, fall within the ambit of patent protection afforded to this application, in line with its underlying concept.

What is claimed is:

1. A limiting structure, comprising:
a mounting component configured to install a microphone boom;
a support component, movably connected to the mounting component; and
a locking component, a first end of the locking component connected to the support component and a second end of the locking component connected to the mounting component to secure or release the support component and the mounting component.

2. The limiting structure according to claim 1, wherein the mounting component is provided with a limiting slot, and one end of the locking component housed within the limiting slot;
wherein in response to unlocking of the locking component, the locking component is moveable in a length direction of the limiting slot, enabling the support component to move relative to the mounting component; and
wherein in response to locking of the locking component, the locking component is secured at a position within the limiting slot, thereby locking the support component and the mounting component.

3. The limiting structure according to claim 2, wherein the locking component comprises an operating part and a movable part;
wherein a first end of the movable part is connected to the support component, and a second end of the movable part is provided with a sliding body configured to glide within the limiting slot; and
wherein the operating part is connected to an end of the movable part distant from the limiting slot, and in response to an operation of the operating part, the sliding body is lockable within the limiting slot or slidable along the limiting slot.

4. The limiting structure according to claim 3, wherein a limiting projection extends inwardly from a peripheral wall of the limiting slot, restricting the sliding body within the limiting slot.

5. The limiting structure according to claim 2, wherein the mounting component comprises a mounting part and a limiting part; and
wherein the limiting part is provided between the mounting part and the support component, the limiting part comprises the limiting slot, and the limiting slot is configured to limit a movement range for the locking component.

6. The limiting structure according to claim 5, wherein the limiting part comprises a connecting strip, a stiffener, and a limiting frame;
wherein a first end of the connecting strip is provided between the support component and the mounting part, and a second end of the connecting strip is connected to the limiting frame; and
wherein the limiting frame comprises the limiting slot, and a first end of the stiffener is connected to one end of the limiting frame, and a second end of the stiffener is connected to an end of the connecting strip distant from the limiting frame.

7. The limiting structure according to claim 6, wherein an avoidance space is formed at an end of the limiting frame distant from the stiffener.

8. A support mechanism, comprising a support rod and the limiting structure according to claim 1, and the support rod is configured to movably connected to the support component.

9. The support mechanism according to claim 8, further comprising a regulating component, comprising a connected regulating part and a resistance part;
wherein the support component is movably connected to the support rod and comprises a first mounting hole; and
wherein the regulating part is movably disposed within the first mounting hole, enabling the resistance part to shift relative to the support component to resist the support rod.

10. An audio stand, comprising a microphone boom and the support mechanism according to claim 9.
